(19) United States
(12) Patent Application Publication
(10) Pub. No.: US 2010/0008713 A1
(43) Pub. Date: Jan. 14, 2010

(54) Pivot Joint Assembly

(75) Inventors: Finlay Jonathan Evans, Colerne (GB); David Roberts McMurtry, Dursley (GB)

Correspondence Address: OLIFF & BERRIDGE, PLC, P.O. BOX 320850, ALEXANDRIA, VA, 22320-4850, US

(73) Assignee: Renishaw PLC, Wotton-Under-Edge (GB)

(21) Appl. No.: 12/308,268

(22) PCT Filed: Jun. 8, 2007
(86) PCT No.: PCT/GB2007/002134

§ 371 Date: Dec. 11, 2008

(30) Foreign Application Priority Data
Jun. 16, 2006 (GB) 0611985.3
Jun. 30, 2006 (GB) 0612914.2

(51) Int. Cl. F16C 11/06

(52) U.S. Cl. 403/114

(57) ABSTRACT

A pivot joint assembly is described that includes a multi-axis revolute joint portion and a ball joint portion. The multi-axis revolute joint portion provides rotational movement about two or more revolute axes that substantially intersecting at an intersection point. The ball joint portion comprising a ball located in the vicinity of said intersection point. The pivot joint assembly allows separate coupling of load members and metrology members to one or more platforms. A hexapod co-ordinate measuring machine including such pivot joint assemblies is also described.

The present invention relates to pivot joints and in particular to high precision pivot joints for use in non-Cartesian measuring machines such as hexapod co-ordinate measurement machines (CMMs) and the like.

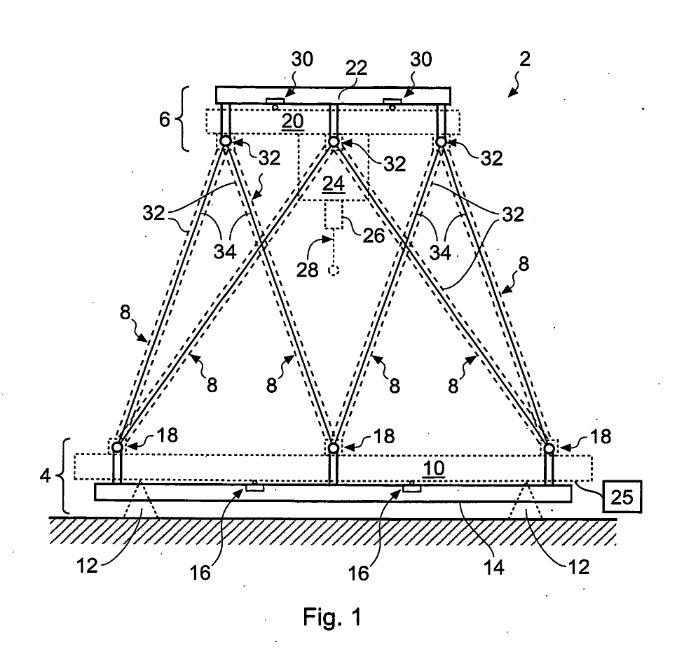

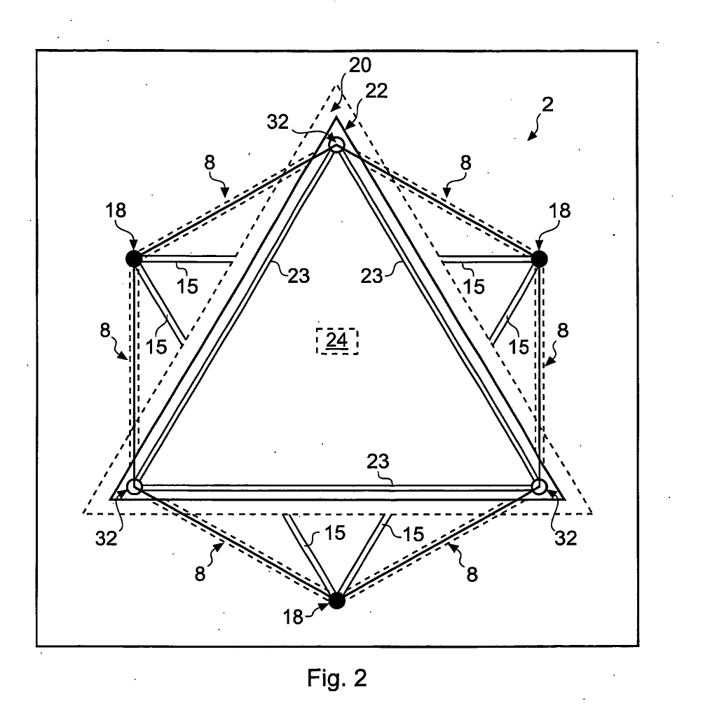

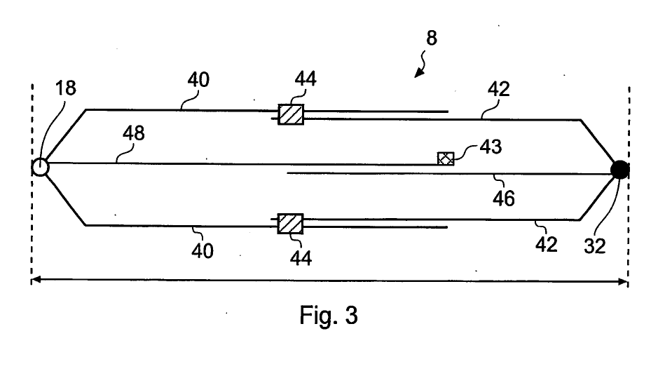

A variety of non-Cartesian machines are known. For example, various hexapod arrangements are described in U.S. Pat. No. 5,028,180 and U.S. Pat. No. 5,604,593. In particular, U.S. Pat. No. 5,028,180 describes various embodiments of a hexapod machine tool comprising an upper, moveable, platform that is attached to a base by six hydraulic extendable legs. In a first embodiment described in U.S. Pat. No. 5,028,180 with reference to FIGS. 1 and 2, the extendable legs are attached to the base and moveable platform by ball and socket joints. In a second, alternative, embodiment that is described in U.S. Pat. No. 5,028,180 with reference to FIGS. 3-5 the extendable legs are attached to the base and moveable platform via so-called trunnion or Hooke's joints. In both described embodiments, the extendable legs are hydraulic and comprise a piston rod that is moveable within a cylinder. The amount of leg extension is measured by mounting a magnetic scale to the cylinder and a suitable readhead on the piston rod. A computer controller is provided to set the length of each leg to provide the required platform movement. U.S. Pat. No. 5,604,593 describes a variant of the above described hexapod apparatus in which the extendable legs are attached to the platform by ball joints and the length of each extendable leg is measured interferometrically.

According to a first aspect of the present invention, a pivot joint assembly comprises; a multi-axis revolute joint portion providing rotational movement about two or more revolute axes, said two or more revolute axes substantially intersecting at an intersection point; and a ball joint portion comprising a ball located in the vicinity of said intersection point.

The present invention thus provides a pivot joint formed from a ball joint portion and a multi-axis revolute joint portion. The multi-axis revolute joint portion (which may comprise a trunnion joint, Hooke's joint etc) allows rotation about a plurality of revolute axes that at least approximately intersect at an intersection point. The ball of the ball joint portion is advantageously located as close as possible to the intersection point of the multi-axis revolute joint so that the ball and revolute joints provide rotation about (at least approximately) the same point in space. Preferably, the centre of the ball substantially coincides with the intersection point such that there is a minimal difference in position of the rotational centres of the multi-axis revolute and the ball joint portions.

The pivot joint of the present invention thus permits two or more mechanically separate members to be rotated about a common pivot point (i.e. the intersection point) by the pivot joint and revolute joint portions. For example, and as described in more detail below, one or more metrology members can be placed in sliding contact with the ball of the ball joint portion and one or more load carrying members can be coupled to the multi-axis revolute joint portion. The metrology members may be mechanically isolated from the load carrying members thereby allowing a load to be transmitted via the multi-axis revolute joint portion without substantially affecting the metrology path through the ball joint portion. A pivot joint of the present invention can thus provide the measurement accuracy benefits associated with ball joints without subjecting the ball joint portion to a significant mechanical load. Instead, the mechanical load is separately routed via the multi-axis revolute joint portion that provides a low friction pivotable coupling which is less susceptible to wear than a ball joint.

It is important to note that the above mentioned prior art (e.g. U.S. Pat. No. 5,028,180) only describes providing trunnion and ball joints as alternatives for attaching extendable legs to a platform. The skilled person would thus have traditionally selected either a ball joint or a trunnion joint when producing a hexapod device. Prior to the present invention, it would thus have been necessary to trade-off accuracy against load carrying capability when selecting the type of pivot joint to include in measurement apparatus. In contrast, the pivot joint of the present invention mitigates the disadvantages associated with both ball and multi-axis revolute joints and provides a pivot joint that can provide both the high accuracy required for metrology whilst allowing mechanical loads to be carried without significant joint wear.

The multi-axis revolute joint portion may allow rotation of one member attached thereto or it may allow the independent rotation of a plurality of such members. To provide such rotational movement, the multi-axis revolute joint portion may comprise multiple (e.g. three) parts attached to each other by multiple (e.g. two) joints that each allow rotation about one axis. Advantageously, the multi-axis revolute joint portion comprises at least a first part, a second part and a third part. Conveniently, the first part is rotatable relative to the second part about a first revolute axis. Advantageously, the second part is rotatable relative to the third part about at least one second revolute axis, wherein the first and second revolute axes substantially intersect at said intersection point.

The first part is conveniently attached to a load carrying platform and may comprise a support or load structure; for example, the first part may comprise a central support pillar or a central load structure that is co-axial with the first revolute axis. Alternatively, the first part may comprise a plurality of arms located around the first revolute axis. The first part may, for simplicity, also be thought of as a fixed part relative to which the second and third parts rotate.

The second part conveniently comprises at least first and second carriages that are rotatably mounted to the first part. Preferably, each of the at least first and second carriages are separately rotatable substantially about the first revolute axis. For example, the first and second carriages may be rotatably mounted to a central support pillar of the first part via one or more bearings. Alternatively, the second part may comprise a ring or similar structure that is pivotally mounted to a pair of support arms of the first part.

The third part may comprise the end of at least one load carrying member or may be attached or attachable to the end of at least one load carrying member. The third part may thus conveniently include one or more load carrying members that are coupled to the second part. Advantageously, the third part comprises the end of a first load carrying member that is rotatably mounted to the first carriage of the second part. Conveniently, the third part also comprises the end of a second load carrying member that is rotatably mounted to the second carriage of the second part. Advantageously, the at least first and second load carrying members are rotatably mounted to the first and second carriages via one or more bearings. The second revolute axes of the first and second load carrying members relative to the first and second carriages are preferably arranged to substantially intersect at said intersection point. If the second part comprises a ring or similar structure as described above, the load carrying member(s) may be pivotally mounted to that ring.

The ball joint portion of the pivot joint preferably comprises a high precision, substantially spherical, ball. For example, the ball may be a ball bearing that is formed by a lapping process. The ball joint portion may also comprise a stalk that is attached to the ball. For example, the ball may comprise a threaded recess into which a complimentary threaded protrusion on the end of the stalk is attached. Alternatively, the ball may be glued, welded etc to the stalk. The ball may be attached to a metrology platform. For example, the ball may be attached to such a metrology platform by the stalk. Advantageously, one or more metrology members are provided that are in sliding contact with the ball. The metrology members may be biased into contact with the ball, or they may include a socket for engaging and riding over the surface of ball. Alternatively, a socket may be attached to the metrology platform and the ball provided on the end of a metrology member. In all cases, it is preferred that the ball is located in the vicinity of the intersection point defined by the multi-axis revolute joint so that rotation of load carrying and metrology members is centred about substantially the same point.

As described above, part of the multi-axis revolute joint portion may be attached to a load-carrying platform. For example, a first part of the multi-axis revolute joint may comprise a support structure affixed to the load-carrying platform. Such a load-carrying platform may be substantially mechanically isolated from a metrology platform to which the ball (or socket) of the ball joint is attached such that distortion of the metrology platform is not induced when the load-carrying platform is distorted. For example, the central support or load structure of the multi-axis revolute joint may comprise a central opening through which a stalk for holding a ball passes. The metrology platform may also be attached to the load carrying platform by a mount that prevents distortions being transmitted from the load carrying platform to the metrology platform.

The pivot joint of the present invention thus makes it possible to provide a measuring machine (e.g. a hexapod) having a load-carrying frame and a separate metrology frame. In particular, the ball joint portion may be substantially mechanically isolated from the multi-axis revolute joint portion. The metrology frame is then unaffected by any distortions induced in the load-carrying frame and thus ensures metrology accuracy is maintained. The provision of separate load-carrying and metrology frames is described in more detail in our co-pending international (PCT) application that claims priority from British patent application 0612914.2 (agents' ref: 695).

Although the pivot joint may provide independent coupling to separate metrology and load bearing frames as mentioned above, the multi-axis revolute joint portion and the ball joint portion may alternatively be mechanically connected at one or more points. The multi-axis revolute joint portion and the ball joint portion are thus conveniently attached to a common load carrying and metrology platform. For example, the first part of the multi-axis revolute joint portion may carry a stalk to which the ball of the ball joint portion is attached. In this manner, metrology and load-carrying members may be attached to a common part of the pivot joint via the ball joint and multi-axis revolute joint portions respectively. This arrangement can be seen to also provide the advantages of passing the load through the multi-axis revolute joint portion whilst the metrology makes use of the ball joint.

Preferably, the pivot joint is coupled to at least one leg assembly. Each leg assemble may comprise a metrology member and a load-carrying member. Advantageously, the pivot joint may be coupled to a plurality of such leg assemblies; for example, the end of two leg assemblies may terminate at a single pivot joint. The leg assembly may have a first end and second end and metrology apparatus for measuring the separation between the first end and the second end. The metrology apparatus may comprise at least one elongate metrology member, wherein the at least one elongate metrology member has a low coefficient of thermal expansion. The metrology structure of the leg assembly may be substantially mechanically isolated from the load carrying path through that leg assembly. The provision of a telescopic leg assembly having separate load-carrying and metrology structures is described in more detail in our co-pending international (PCT) application that claims priority from British patent application 0611985.3 (agents' ref: 693).

As outlined above, the multi-axis revolute joint portion is arranged such that the ball of the ball joint portion can be located in the vicinity of the intersection point. Preferably, the intersection point is located within the volume occupied by the ball and more preferably the intersection point substantially coincides with the centre of the ball. The multi-axis revolute joint portion thus preferably surrounds or encloses the ball of the ball joint. In this manner, both joints provide the freedom of rotational movement that allows the necessary pivoting motion.

The pivot joint described herein may be used for any application, however it is particularly suited for use in measuring equipment. Advantageously, a measuring machine may be provided that comprises at least one platform and at least one extendable leg, wherein the at least one extendable leg is linked to the at least one platform by a pivot joint assembly as described above. The measuring machine conveniently comprises a hexapod arrangement having six legs linking two platforms. In particular, the pivot joint may be incorporated in the improved access hexapod CMMs that are described in our co-pending International (PCT) patent application that claims the priority of British patent application No. 0611979.6 (agents' ref 691).

According to a second aspect of the invention, a combination joint for a measuring machine comprises a Hooke's joint portion and a ball joint portion. Advantageously, the centre of the ball joint is substantially coincident with the revolute axes of the Hooke's joint.

According to a third aspect of the invention, a machine comprises a pair of relatively moveable platforms, wherein a plurality of powered extendable legs and a plurality of extendable measurement legs extend between said platforms, wherein said powered extendable legs are attached to the platforms by multi-axis revolute joints (e.g. Hooke's joints) and the extendable measurement legs are attached to the platforms by ball joints. The multi-axis revolute joints thus carry the load applied by the powered legs, whilst the ball joints provide higher accuracy for the measurement legs of the metrology structure. A machine, e.g. a hexapod, may thus be provided that has separate measurement legs and powered legs. The measurement legs may be arranged to be substantially parallel to the powered legs. Alternatively, the measurement and powered legs may be provided in different configurations. A computer or other controller may be provided to control the powered extendable legs and also to receive measurement from the extendable measurement legs.

The invention will now be described, by way of example only, with reference to the accompanying drawings in which;

FIG. 1 shows a side-on view of a hexapod CMM incorporating pivot joints of the present invention,

FIG. 2 shows a top view of the hexapod shown in FIG. 1,

FIG. 3 illustrates an extendable powered leg of the type shown in FIGS. 1 and 2 in more detail,

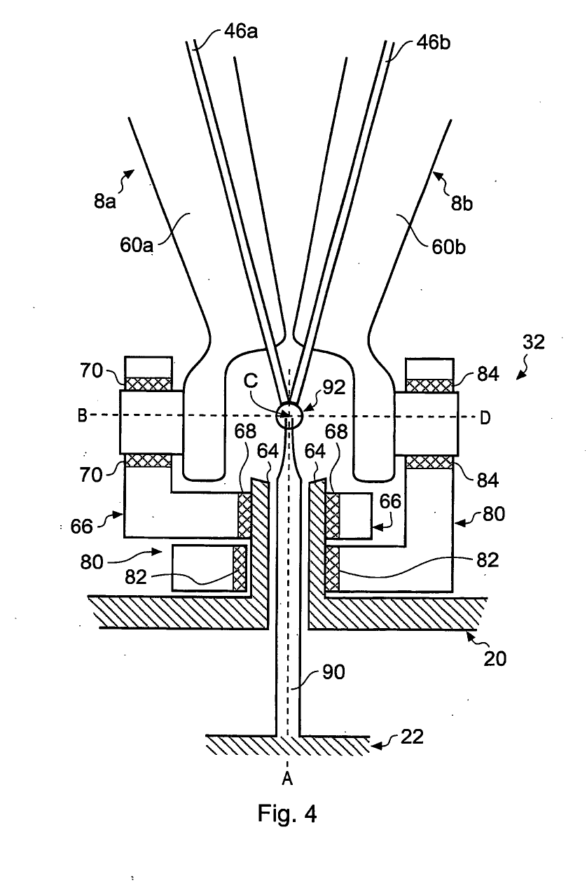

FIG. 4 illustrates a first pivot joint of the present invention having separate load bearing and metrology paths,

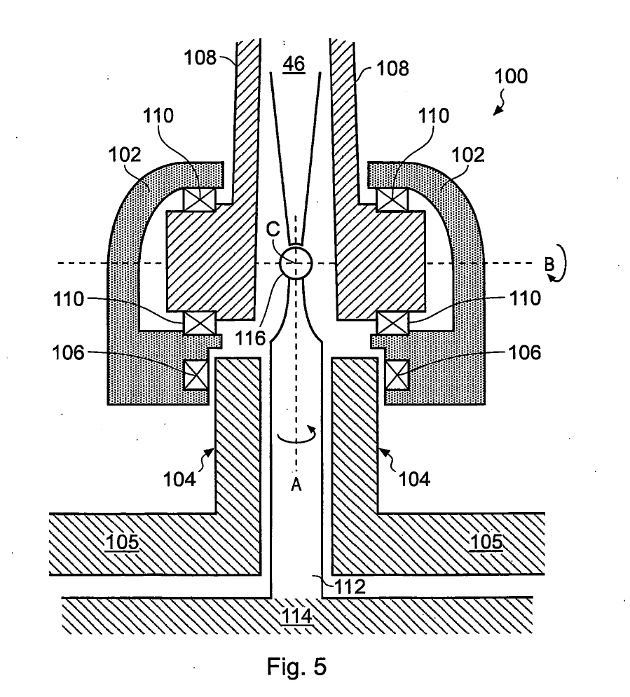

FIG. 5 illustrates a second pivot joint of the present invention having separate load bearing and metrology paths,

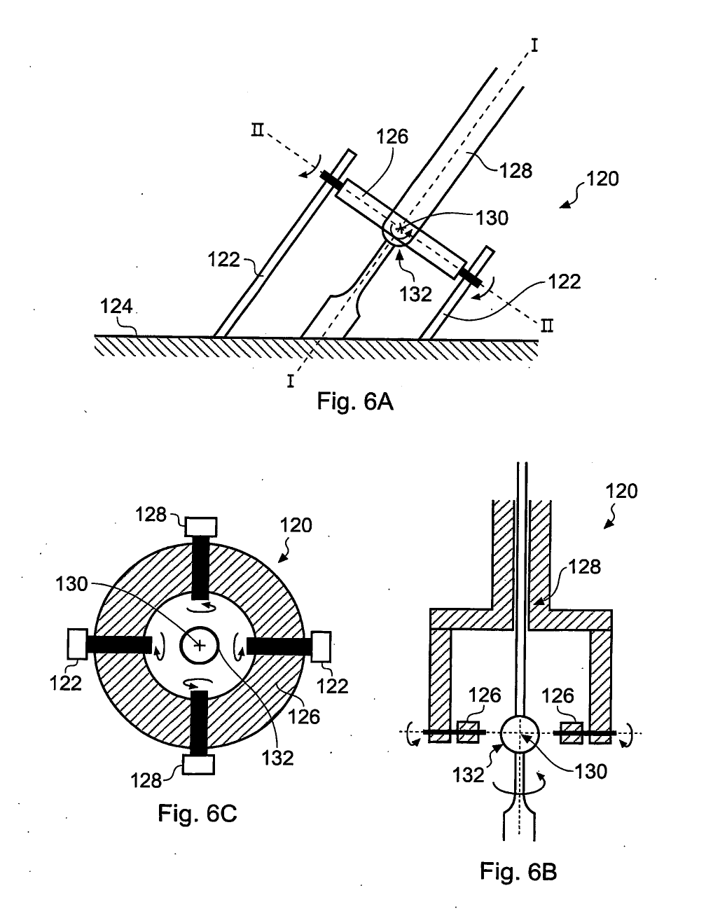

FIG. 6 illustrates a third pivot joint of the present invention,

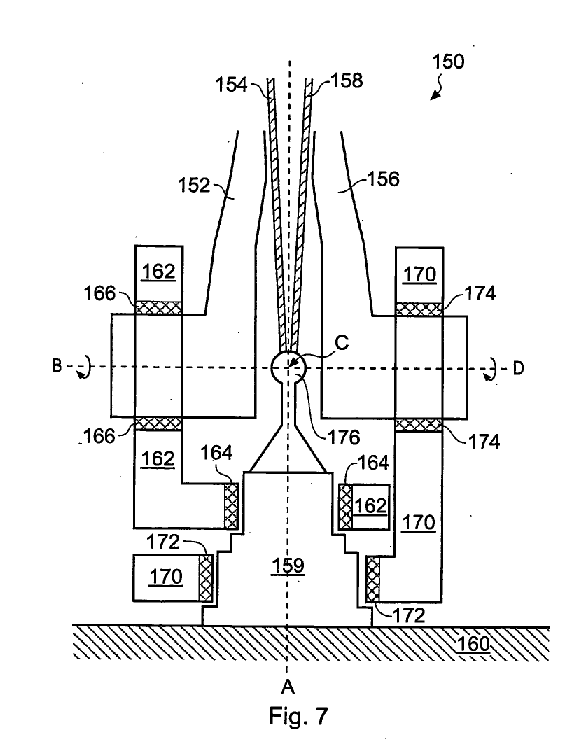

FIG. 7 illustrates a fourth pivot joint of the present invention, and

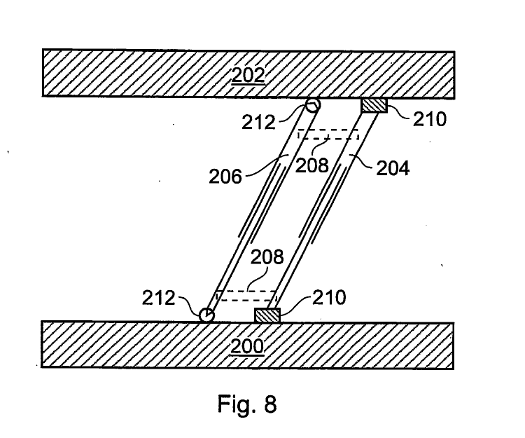

FIG. 8 illustrates how separate metrology and load bearing joints may be provided for a CMM.

Referring to FIGS. 1 and 2, a hexapod co-ordinate measuring machine 2 is illustrated. In particular, FIGS. 1 and 2 show side-on and top views of the hexapod CMM 2 respectively. The hexapod CMM 2 comprises a lower base portion 4 and an upper moveable platform portion 6 that are spaced apart by six extendable legs 8.

The base portion 4 comprises a lower load bearing platform 10, such as granite slab, that is grounded via a plurality of support legs 12. A lower metrology platform 14 that includes a triangular framework of INVAR struts 15 is mounted to the underside of the lower load bearing platform 10 by mounts 16. Each mount 16 includes a magnet and a kinematic locating means. The mounts 16 are arranged to ensure that the lower metrology platform 14 is maintained in a well defined, repeatable, position relative to the lower load bearing platform 10 in such a way that no force or load is transmitted from the lower load bearing platform 10 to the lower metrology platform 14. Three pivot joints 18 are also provided that separately couple the lower load bearing platform 10 and the lower metrology platform 14 to the extendable legs 8.

The moveable platform portion 6 comprises an upper load bearing platform 20 and an upper metrology platform 22. The upper metrology platform 22 comprises a triangular framework of INVAR struts 23 and is attached to the upper load bearing platform 20 via mounts 30. The mounts 30 locate the upper load bearing platform 20 relative to the upper metrology platform 22 but are arranged such that no load is passed to the upper metrology platform 22 from the upper load bearing platform 20. Three pivot joints 32 are also provided that separately couple the load bearing platform 20 and the metrology platform 22 to the extendable legs 8. In this example, the mounts 30 and pivot joints 32 are of the same type as the mounts 16 and pivot joints 18 of the base.

A quill 24 is attached to the underside of the upper load bearing platform 20 and is arranged to retain a measurement probe 26 having a stylus 28 with a spherical stylus tip. The measurement probe may be a touch trigger probe or any measurement probe of known type.

The six extendable legs 8 that link the lower base portion 4 and the upper moveable platform portion 6 each have a load bearing structure (indicated by dotted lines 32) and a metrology structure (indicated by the solid lines 34). The metrology structure 34 of legs is mechanically isolated from the load bearing structure 32. The extendable legs 8 also comprise drive means (e.g. a motor) to extend/retract the legs. The metrology structure 34 of the legs 8 is formed from INVAR and also comprises means (e.g. an optical encoder) for measuring leg length. The structure of the extendable legs 8 is described in more detail below with reference to FIG. 3.

The joints 18 of the base portion 4 and the joints 32 of the moveable platform portion 6 allow the lower load bearing platform 10 to be linked to the upper load bearing platform 20 via the load bearing structure 32 of the extendable legs. The same joints 18 also allow the lower metrology platform 14 to be linked to the upper metrology platform 22 via the metrology structure 34 of the legs. The arrangement of the joints and legs is such that separate load and metrology frames are provided thereby ensuring that any distortion of the load carrying components does not cause distortion of the metrology frame. Furthermore, the metrology frame (i.e. the lower metrology platform 14, the upper metrology platform 22 and the metrology structure 34 of the extendable legs) are all formed from INVAR™. INVAR has a low coefficient of thermal expansion and the metrology frame is thus substantially unaffected by any changes in the thermal environment. The kinematic mounts 16 and 30 between the metrology frame and the load carrying frame also ensure that no distortion of the metrology frame is induced by thermal expansion of the load carrying parts of the apparatus.

In use, an object (e.g. a workpiece) to be measured is placed on the load bearing base 10. The length of each extendable leg 8 is controlled by an associated computer controller 25. Altering the length of the various legs allows the moveable platform portion 6, and hence the quill 24, to be moved relative to the base. This arrangement allows the form of the object to be measured.

Referring to FIG. 3, an extendable leg 8 of the above described hexapod is illustrated. The extendable leg 8 comprises an outer tubular portion 40 and an inner tubular portion 42. The inner tubular portion 42 is slidable within the outer tubular portion 40 thereby forming a telescopically extendable leg. A drive means 44 allows expansion and contraction of the leg as required. The drive means 44 is illustrated schematically in FIG. 3 and may comprise any arrangement that introduces relative axial motion between the inner and outer tubular portions. For example, the drive means may be a hydraulic piston, screw jack or may comprise an electronic drive arrangement. In use, the drive means 44 causes expansion and contraction of the extendable leg thereby urging the lower base portion 4 and moveable platform portion 6 apart, or pulling them together, as required. The load is transmitted through the extendable leg 8 via the tubular portions.

In addition to the tubular (load bearing) portions 40 and 42, the extendable legs 8 also comprises a separate metrology structure. The metrology structure comprises a first metrology member 46 and a second metrology member 48. The first metrology member 46 is an elongate member on which a optical scale is formed. Movement of the first end of the first metrology member 46 along the axis of the leg 8 is constrained only in the vicinity of the joint 32. The second end of the first metrology member 46 is free to move longitudinally, although it may be supported by the surrounding inner tubular portion 42 so as to prevent lateral movements. The second metrology member 48 is also in the form of an elongate member. Movement of the first end of the second metrology member 48 along the axis of the leg 8 is constrained only in the vicinity of the joint 18. The second end of the second metrology member 48 is thus free to move longitudinally, although it may be supported by the surrounding outer tubular portion 40 so as to prevent radial movements. The second end of the second metrology member 48 carries an optical readhead 43 that is suitable for reading the optical scale of the first metrology member 46. In this manner, any relative movement between the first and second members can be measured. Although an optical scale and readhead arrangement is shown in FIG. 3, it should be noted that non-optical position encoders (e.g. magnetic or capacitance systems) could alternatively be used.

The first and second metrology members 46 and 48 are fabricated from INVAR which, as noted above, is a material having a low coefficient of thermal expansion. Also, it should be remembered that the first and second metrology members 46 and 48 are not axially constrained by the inner and outer tubular portions 40 and 42 of the leg. Therefore, any thermal expansion or distortion of the inner and outer tubular portions 40 and 42 is not transmitted to the first and second metrology members 46 and 48.

Each extendable leg 8 thus has integral metrology means for measuring length that are unaffected by any thermal expansion or contraction of the load bearing structure of that leg. The arrangement thus provides a metrology structure through which no load is transmitted. In other words, the extendable leg 8 could be said to comprise a load bearing structure (i.e. the tubular portions 40 and 42) that is separate from the metrology structure (i.e. the metrology members 46 and 48). More details about extendable legs of this type can be found in applicant's co-pending international (PCT) application that claims priority from British patent application 0611985.3 (agents' ref: 693).

Referring now to FIG. 4 a joint 32 of the above described hexapod is shown in more detail. As outlined above, joint 32 allows the load bearing and metrology structures of two extendable legs 8a and 8b to be coupled to the load bearing platform 20 and metrology platform 22 respectively. The joint 32 is arranged to receive a first load bearing end member 60a that is located at the end of an inner tubular portion 42 of extendable leg 8a. A metrology member 46a of leg 8a is also received by the joint 32. A second load bearing end member 60b and metrology member 46b are also received from a second extendable leg 8b.

The joint 32 comprises a central load structure 64 that is anchored to the load bearing platform 20. A first carriage 66 is mounted to the central load structure 64 via bearings 68 in such a manner that it can rotate about a first axis of rotation A. The first load bearing end member 60a carries a protrusion that allows it to be rotatably mounted to the first carriage 66 via bearings 70 such that it is rotatable about a second axis of rotation B. Axes A and B substantially intersect at a point C and the joint 32 thus allows the first load bearing end member 60a to rotate about an intersection or centre point C with two rotational degrees of freedom.

A second carriage 80 is also mounted to the central load structure 64 via bearings 82 in such a manner that it is rotatable about an axis that is substantially coincident with the first axis of rotation A. The second load bearing end member 60b carries a protrusion such that it can be rotatably mounted to the second carriage 80 via bearings 84 such that it is rotatable about a further axis of rotation D which also substantially intersects the centre point C. In this manner, the joint 32 also allows the second load bearing end member to rotate substantially about the centre C with two rotational degrees of freedom.

The central load structure 64 has an aperture through which a stalk or elongate member 90 is passed. One end of the elongate member 90 is attached to the metrology platform 22 whilst the other end carries a ball 92. The centre of the ball 92 is arranged to substantially coincide with the centre C. The metrology members 46a and 46b of the two extendable legs make direct contact with the ball 92. Appropriate sockets (not shown) may be provided to keep the end of the metrology members 46a and 46b in contact with the ball 92 or the metrology members may be biased (e.g. spring loaded) to provide such contact. Although the elongate member 90 is passed through an aperture in the central structure 64, it should be noted that it may pass through any appropriate part of the joint structure.

Joint 32 thus allows two extendable arms of the type described with reference to FIG. 3 above to be attached to load carrying and metrology platforms. The outer Hooke's joint arrangement provides the load bearing couplings whilst the metrology paths are provided via a ball joint. It should be noted that, in this example, the structure of joint 18 of the base portion 4 is similar to the structure of joint 32 of the moveable platform portion 6; joint 18 providing separate couplings to the lower load bearing platform 10 and the lower metrology platform 14.

Referring to FIG. 5 a variant of the joint described with reference to FIG. 4 is illustrated. The joint 100 shown in FIG. 5 is suitable for connecting a single extendable leg to load bearing and metrology platforms. This may be required where variants of the hexapod design described with reference to FIGS. 1 to 4 are implemented; for example, in a hexapod of the type described in our International (PCT) patent application that claims the priority of British patent application No. 0611979.6. (agents' reference 691).

The joint 100 comprises a carriage 102 that is mounted to a central load structure 104 via bearings 106 in such a manner that it can rotate about a first axis of rotation A. The load bearing structure 104 is mounted to a load bearing platform 105. A load bearing end member 108 from the extendable arm carries a protrusion such that it can be rotatably mounted to the carriage 102 via bearings 110 such that it is rotatable about a second axis of rotation B such that axis A and axis B substantially intersect at point C. In this manner, the joint 100 allows the load bearing end member 108 to rotate about a centre C with two rotational degrees of freedom.

The central load structure 104 has an aperture through which an elongate member 112 is passed. One end of the elongate member 112 is attached to an associated metrology platform 114 whilst the other end carries a ball 116. The centre of the ball 116 is arranged to substantially coincide with the centre C. A metrology member 46 of the extendable leg make direct contact with the ball 116. Appropriate sockets (not shown) may be provided to keep the end of the metrology member 46 in contact with the ball 116 or the metrology member may be spring loaded to provide such contact.

Although the pivot joint of the present invention may be used with two platforms (i.e. a load bearing and a metrology platform) as described above, it is also possible to separately couple the load bearing and metrology paths to a common platform.

Referring to FIG. 6, a pivot joint 120 providing a separate metrology and load bearing path to a common surface of a platform is illustrated. In particular, FIG. 6a shows a side view of the joint 120, whilst FIGS. 6b and 6c show cross-sectional views along lines I-I and II-II of FIG. 6a respectively.

Pivot joint 120 comprises a pair of parallel arms 122 that protrude from the surface of a platform 124. The pair of arms 122 are pivotally mounted to a ring 126 at diametrically opposed locations. A Y-shaped load bearing member 128 is, in turn, pivotally mounted to the ring 126 at two diametrically opposed points. This provides a so-called Hooke's joint having two substantially intersecting revolute axes; the two revolute axes allowing pivoting about a centre of rotation 130. The Hooke's joint carries the mechanical load from the load bearing member 128 to the platform 124.

The joint 120 also comprises a ball 132 that is attached to the platform 124 and arranged such that its centre substantially coincides with the point of intersection of the revolute axes of the Hooke's joint. A metrology member 130 extends co-axially with the shaft of the load bearing member 128. The end of the metrology member 130 makes direct contact with the ball 132. A ball joint is thus provided purely for metrology purposes; i.e. no load is transmitted through the ball joint.

The joint 120 thus allows the load bearing structure and metrology member of an extendable arm to be coupled to a platform through different paths. In particular, the joint 120 provides a Hooke's joint for coupling the load from the arm to the platform; this takes advantages of the low friction and high load carrying capacity of such joint. The joint 120 also comprises a ball joint, which is inherently more accurate than a Hookes joint, to couple the metrology member to the platform. The joint 120 thus combines the advantages of Hooke's joints (i.e. low friction and high load carrying capabilities) with the metrology advantages of ball joints (i.e. high accuracy). The joint 120 shown in FIG. 6 thus permits a single extendable arm of the type described above to be attached to a single platform.

Referring to FIG. 7, a further joint 150 is shown for coupling two extendable legs to a single (common) platform 160. The joint 150 is arranged to receive a first load bearing member 152 and a first metrology member 154 from a first extendable leg. A second load bearing member 156 and a second metrology member 158 are also received from a second extendable leg. The joint also comprises a central structure 159 that is anchored to the platform 160.

A first carriage 162 is mounted to the central structure 159 via bearings 164 in such a manner that it can rotate about a first axis of rotation A. The first load bearing member 152 carries a protrusion on its end such that it can be rotatably mounted to the first carriage 162 via bearings 166 such that it is rotatable about a second axis of rotation B. In this manner, the joint 150 allows the first load bearing member to rotate substantially about a centre C with two rotational degrees of freedom.

A second carriage 170 is also mounted to the central structure 159 via bearings 172 in such a manner that it is rotatable about an axis substantially co-axial with the first axis of rotation A. The second load bearing member 156 carries a protrusion on its end such that it can be rotatably mounted to the second carriage 170 via bearings 174 such that it is rotatable about an axis D that also substantially intersects centre point C. The joint 150 thus also allows the second load bearing member to rotate substantially about centre C with two rotational degrees of freedom.

The central structure 159 also carries a ball 176 on a stalk having a centre which is located so as to substantially coincide with the centre C. The first metrology member 154 and the second metrology member 158 make direct contact with the ball 176. Appropriate sockets (not shown) may be provided to keep the end of the metrology members 154 and 158 in contact with the ball 176 or they may be biased into contact with the ball such that ball contact is maintained under normal operating conditions.

Joint 150 thus allows the ends of two extendable arms of the type described above to be attached to a common platform. The multi-axis revolute joint arrangement thus provides the load bearing couplings whilst the metrology paths are provided via a ball joint. Although two extendable arms are illustrated, it should be noted that more than two arms may be provided if required.

Although combined joints are described above, it should be noted that separate (i.e. spatially separated) multi-axis revolute joints and ball joints could be provided to achieve similar benefits, albeit in a less compact manner.

FIG. 8 illustrates a first (e.g. base) platform 200 that is spaced apart from a second moveable platform 202. A powered extendable leg 204 and a metrology leg 206 are attached to both the first and second platform. The powered extendable leg 204 comprise a drive means (not shown) such that it can be extended or retracted as required. The metrology leg 206 comprises no such drive means but instead includes means for measuring its length. The metrology leg may comprise first and second metrology members of the type described above contained with a (non-powered) telescopic tubular housing. One or more linkages 208 may be provided to keep the powered leg 204 and metrology leg 206 parallel to each other during operation.

The powered extendable leg 204 is attached to both platforms via Hooke's joints 210 whilst the metrology leg 206 is attached to the platforms via ball joints 212. This arrangement allows the metrology benefits associated with ball joints to be combined with the low friction (low wear) benefits of Hooke's joints. It should be noted a CMM would typically comprise a plurality of powered extendable legs and plurality of metrology legs. For example, a hexapod arrangement may be provided having six powered extendable legs and six metrology legs. Although each metrology leg may be adjacent and/or held parallel to a powered leg, this is not strictly necessary because any arrangement of the powered and metrology legs could be provided.

1. A pivot joint assembly comprising;
a multi-axis revolute joint portion providing rotational movement about two or more revolute axes, said two or more revolute axes substantially intersecting at an intersection point; and
a ball joint portion comprising a ball located in the vicinity of said intersection point.

2. A pivot joint assembly according to claim 1 wherein the centre of the ball substantially coincides with the intersection point.

3. A pivot joint assembly according to claim 1 wherein the multi-axis revolute joint portion comprises at least a first part, a second part and a third part, the first part being rotatable relative to the second part about a first revolute axis and the second part being rotatable relative to the third part about at least one second revolute axis, wherein the first and second revolute axes substantially intersect at said intersection point.

4. A pivot joint assembly according to claim 3 wherein the first part comprises a support structure attached to a load carrying platform.

5. A pivot joint assembly according to claim 3 wherein the third part comprises the end of at least one load carrying member or is attachable to the end of at least one load carrying member.

6. A pivot joint assembly according to claim 3 wherein the second part comprises at least first and second carriages rotatably mounted to the first part, each of the at least first and second carriages being separately rotatable substantially about the first revolute axis.

7. A pivot joint assembly according to claim 6 wherein the at least first and second carriages are rotatably mounted to the first part via bearings.

8. A pivot joint assembly according to claim 6 wherein the third part comprises the end of a first load carrying member rotatably mounted to the first carriage and the end of a second load carrying member rotatably mounted to the second carriage, wherein the second revolute axes of the first and second load carrying members relative to the first and second carriages substantially intersect at said intersection point.

9. A pivot joint assembly according to claim 8 wherein the at least first and second load carrying members are rotatably mounted to the first and second carriages via bearings.

10. A pivot joint assembly according to claim 1 wherein one or more metrology members are in sliding contact with the ball.

11. A pivot joint assembly according to claim 1 wherein the ball joint portion comprises a stalk and the ball is attached to a metrology platform by the stalk.

12. A pivot joint assembly according to claim 11 wherein the multi-axis revolute joint portion is attached to a load-carrying platform that is substantially mechanically isolated from the metrology platform such that distortion of the metrology platform is not induced by distortion of the load-carrying platform.

13. A pivot joint assembly according to claim 12 wherein the metrology platform is attached to the load carrying platform by a mount that prevents distortions being transmitted from the load carrying platform to the metrology platform.

14. A pivot joint assembly according to claim 1 wherein the ball joint portion is substantially mechanically isolated from the multi-axis revolute joint portion.

15. A pivot joint assembly according to claim 1 wherein the multi-axis revolute joint portion and the ball joint portion are attached to a common load carrying and metrology platform.

16. A pivot joint according to claim 1 coupled to at least one leg assembly, each leg assemble comprising a metrology member and a load-carrying member.

17. A pivot joint according to claim 16 coupled to a plurality of leg assemblies.

18. A pivot joint assembly according to claim 1 wherein the multi-axis revolute joint portion surrounds the ball of the ball joint.

19. A measuring machine comprising at least one platform and at least one extendable leg, wherein the at least one extendable leg is linked to the at least one platform by a pivot joint assembly according to claim 1.

20. A combination joint for a measuring machine comprising a Hooke's joint portion and a ball joint portion.

21. A joint according to claim 20 wherein the centre of the ball joint is substantially coincident with the revolute axes of the Hooke's joint.

22. A machine comprising a pair of relatively moveable platforms, wherein a plurality of powered extendable legs and a plurality of extendable measurement legs extend between said platforms, wherein said powered extendable legs are attached to the platforms by multi-axis revolute joints and the extendable measurement legs are attached to the platforms by ball joints.
